(19) United States
(12) Patent Application Publication
(10) Pub. No.: US 2025/0207896 A1
(43) Pub. Date: Jun. 26, 2025

(54) ARMORED GLASS PANEL RIGIDLY CONNECTED TO A BODY WITHOUT A FRAME BY MEANS OF BRACKETS AND THROUGH-PINS

(71) Applicant: SAINT-GOBAIN GLASS FRANCE, COURBEVOIE (FR)

(72) Inventor: Adrien BOUTY, SULLY SUR LOIRE (FR)

(21) Appl. No.: 18/847,572

(22) PCT Filed: Mar. 14, 2023
(86) PCT No.: PCT/FR2023/050337

§ 371 Date: Sep. 16, 2024

(30) Foreign Application Priority Data
Mar. 17, 2022 (FR) FR2202342

(51) Int. Cl. F41H 5/26; B32B 17/10; F41H 5/04

(52) U.S. Cl. CPC F41H 5/263; B32B 17/10064; F41H 5/0407

(57) ABSTRACT

A ballistic unit including a laminated glass panel of 4 to 10 sheets of mineral glass with thicknesses between 4 and 12 mm, with adhesive interlayers of thicknesses between 0.1 and 6 mm, of length between 400 and 2000 mm, width between 150 and 500 mm and thickness between 40 and 100 mm; the unit including through-bores of diameters between 1/10 and ⅓ of the thickness thereof, the bores are aligned and regularly spaced along three of the four sides of the unit, their centers being at a distance from the side of at least twice their diameters, and the sum of the diameters of the bores on each side does not exceed ¼ of the length thereof.

Armored land vehicles are fitted with thick glass, the main property of which, apart from its transparency, is to offer protection against ballistic threats such as ammunition and shrapnel.

This type of transparent solution needs to guarantee protection in the face of increasingly severe threats, while limiting the increase in mass and thickness.

The armored transparent solutions most commonly manufactured and marketed are laminates employing the same bank of materials: sheets of glass bonded in pairs consecutively by viscoelastic interlayers constituting a front unit with a thickness e≈100 mm, and an anti-shattering film on the rear face.

This type of assembly utilizes three main impact energy dissipation mechanisms:—brittle fracture of the glass,—viscoelastic deformation of the spacers,—delamination at the glass/spacer interfaces.

The relative contribution of these three mechanisms can be weighted by the individual properties of the components, or their coupling: the glass via the type of reinforcement, the interlayers via their nature and/or formulation, their glass transition temperature, and the interfaces via their functionalization by chemical agents.

In the end, with a fairly limited range of materials and equally limited possibilities for modulation, the solutions offered by armored glass suppliers now have virtually identical weights and thicknesses, to within 10%. This alignment corresponds to positioning the impact resistance of the above-mentioned assemblies at their extreme limit of reliability.

More marginally, document WO 2009/150380 A2 describes other solutions employing materials with higher Young's modulus, such as ceramics and sapphire (crystalline alumina) (˜500 MPa vs. ˜50 MPa for glass). But these solutions, which have been developed over the past decade or two, have not found a market because of their high cost.

Another area of innovation for these solutions is the way in which they are framed, to improve their ease of implementation, installation or replacement of a solution on the complete system, the modularity and adaptability of their frame, and their lightness.

Faced with increasingly severe threats, and failing to break with the glass/interlayer technology described above, there is no choice but to thicken the compositions.

The aim of the present invention is to provide armored glass panels which can reach relatively large dimensions, with a decrease in the effects of the destructive longitudinal mode, by reducing the waveguide effect of the frame. The inventor's idea was to do away with the frame, leaving as much of the lateral edges as possible in direct contact with the environment outside the armored vehicle, i.e. to free up and promote the propagation of transverse shockwave modes. To this end, the object of the invention is a ballistic unit essentially consisting of a laminated glass panel of 4 to 10 sheets of mineral glass with thicknesses of between 4 and 12 mm, bonded in consecutive pairs by an adhesive interlayer with a thickness of between 0.1 and 6 mm, characterized in that the length of the two main faces of each said sheets of mineral glass is between 400 and 2000 mm and their width between 150 and 500 mm, the thickness of the ballistic unit is between 40 and 100 mm, in that the ballistic unit comprises through-bores in the direction of the thickness thereof, in that the diameter of the bores is between 1/10 and ⅓ of the thickness of the ballistic unit and between 4 and 33 mm, and in that the bores are positioned along three of the four sides or edges of the two main faces of each said sheet of mineral glass, so that their centers are at a distance from said corresponding side or edge of at least twice their diameters, and in that the bores are aligned, regularly spaced from one another and in a number such that the sum of the diameters of the bores aligned along said side or edge does not exceed ¼ of the length of said side or edge.

As will be seen in greater detail below, the bores correspond to the attachment points of the ballistic unit, and the side thereof that is free of them is that which is intended to be the lower side in the assembly position: this arrangement is designed to attach the ballistic unit only by its sides that do not have any weight-induced stress, that is its right, left and upper sides. This is not the case with the fourth, lower side, which has no bores, and by which the ballistic unit is intended to be supported by brackets, as we shall see later.

The structure of the ballistic unit made of a laminated glass panel according to the invention does not exclude its main face, intended to be in contact with the interior volume of the vehicle or building, in the mounted position, from being made of a shatterproof sheet, for example made of 6 mm thick polycarbonate (PC), bonded to the laminated structure by a layer of thermoplastic polyurethane (TPU).

On the other hand, the sum of the diameters of the bores on a side or edge cannot exceed ¼ of its length, so as not to weaken the structure of the ballistic unit too much.

The ballistic unit according to the invention provides high ballistic resistance for a relatively large transparent surface.

Preferably, each said sheet of mineral glass is soda-lime glass, aluminosilicate, borosilicate or similar, such as float glass, is chemically strengthened, thermally toughened, hardened or unhardened.

Preferably, each said adhesive interlayer is selected from a layer of polyvinyl butyral (PVB), polyurethane (PU), ethylene-vinyl acetate copolymer (EVA), polycarbonate (PC), polyethylene terephthalate (PET), casting resin or ionomer resin, or a combination of several of these layers.

Preferably, as previously mentioned, the main face of the ballistic unit located on the side opposite that from which an impact is expected, that is in contact with the interior of a vehicle or building in the mounting position, is made of a polycarbonate (PC) shatterproof sheet.

Preferably, the ballistic unit is at least 60 mm thick.

The invention also relates to a kit comprising a ballistic unit described above, through-pins each intended to participate in the fastening of the ballistic unit through its mounting environment and through each said bore, these through-pins each consisting of a screw, an elastomer sleeve, a spring, and a nut, for fastening the ballistic unit securely to its mounting environment.

Preferably, each elastomer sleeve has a length equal to the thickness of the ballistic unit.

Preferably, each elastomer sleeve has an outer envelope with a geometry identical to that of the ballistic unit bore into which it is to be inserted.

Preferably, each elastomer sleeve has a cylindrical recess with an internal diameter equal to the diameter of its associated fastening screw.

Preferably, at least one elastomer sleeve has a tapered outer envelope with a small cross-section facing the armature. The cylindrical hollow of the elastomer sleeve is coaxial with the conical envelope. This tapered profile provides a better balance between the force exerted by the screw+sleeve assembly, which holds the glass sheet (ballistic unit) in position on the armature, and the force exerted by the spring, which tends to push the glass sheet away from the armature.

Preferably, at least one screw has a hexagonal head. This is preferable for better control of the tightening torque, and indirectly of the degree of spring compression at the end of installation.

Another object of the invention is an assembly with increased resistance to bullets and/or shrapnel and/or other high-energy projectiles, comprising a ballistic unit, elements for fastening same to a mounting environment, and this mounting environment, wherein one face of said ballistic unit intended to be in contact with the external atmosphere is defined as the front face, the opposite face intended to be in contact with the interior volume of the mounting environment is defined as the rear face, and any faces perpendicular to the front and rear faces are side faces of the ballistic unit, the rear face of the ballistic unit is of dimensions greater than those of an opening in the wall of the mounting environment, in front of which said ballistic unit is intended to be fastened, said wall constitutes an armature having a front or outer face and a rear or inner face, the front face of the armature constitutes an element for holding and locking said rear face of the ballistic unit, characterized in that said assembly comprises an outer armature structure which consists of brackets rigidly connected to the armature and protruding past the front face thereof, which comprise at least two brackets supporting the ballistic unit by its lower lateral face, and almost all its weight, securing the ballistic unit in its vertical position, and at least two brackets in right and left position with respect to the ballistic unit, so as to secure it in its horizontal position, in that said elements for fastening the ballistic unit comprise through-pins which are each made up of a screw, an elastomer sleeve, a spring and a nut, for fastening the ballistic unit securely to the armature, in that each screw is inserted into an elastomer sleeve, in that all the screws and elastomer sleeves pass through the ballistic unit via bores drilled therein, in that each nut is in contact with the inner face of the armature, opposite a bore therein, in that each spring is placed between the outer face of the armature and the rear face of the ballistic unit, and in that in the fastened position of the ballistic unit, each screw is secured to a nut, and each spring is constrained to a length of between 50 and 100% of its no-load length (that is not, or slightly, compressed).

If there are at least three brackets supporting the ballistic unit on its lower lateral face, they are equidistant so as to distribute the weight of the ballistic unit evenly between them.

Replacing the conventional frame with a system of point attachments leads to a significant reduction in the longitudinal mode induced by the waveguide effect of an above-described frame.

In addition, the springs positioned between the glass panel and the armature are designed to non-destructively dissipate the vibratory modes induced by the movement of the vehicle on uneven ground, on the one hand, and on impact by an object such as shrapnel, on the other hand, part of the quantity of movement transferred from the said shrapnel to the glass panel.

The number of through-pins in the ballistic unit, and their profiles and dimensions, particularly their diameter, are a function of the dimensions of the ballistic unit: the thicker and therefore heavier the ballistic unit, the larger the diameter of the bores drilled in the ballistic unit and of the outer casing of the elastomer sleeves. It's easy for specialists to optimize the diameter (or size, depending on the size of the cross-section) of through-pins, and their number, so as to guarantee the required fastening without excessively reducing the transparent volume available for direct vision. Similarly, the number of through-pins must be sufficient to hold the unit securely onto the armature, without exceeding what is necessary so as to avoid introducing an excess of bores into the unit, which could excessively reduce the area of vision (transparency) for a vehicle passenger.

The number of retaining brackets can be dictated by simple aesthetic issues of vehicle design and/or ergonomics.

Preferably, each bracket is in contact with a side face of the ballistic unit via an elastomer pad.

Another object of the invention is the use of a ballistic unit described above, as glass panel with increased resistance to bullets and/or shrapnel and/or other high-energy projectiles, in particular as a side glass panel for armored vehicles. These include Bastion, Sherpa and VAB armored land vehicles marketed by Arquus, and Griffon and Titus vehicles marketed by Nexter. It is worth noting that this glass panel can have a relatively large surface area.

The invention will be better understood in light of the following description of the appended drawings, wherein

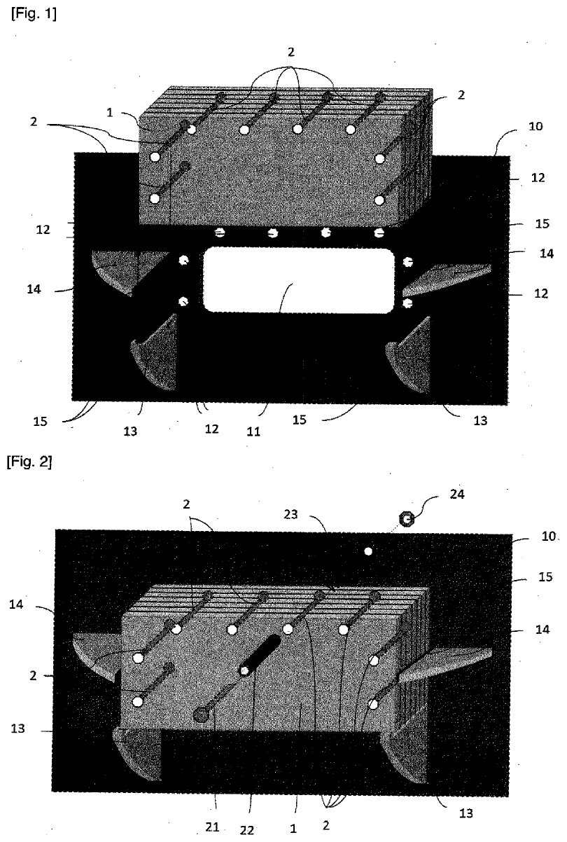

FIG. 1 is a schematic perspective representation of an assembly according to the invention, in the vicinity of an external armature structure with brackets and bores to accommodate the assembly;

FIG. 2 is a schematic perspective view of the assembly shown in FIG. 1, positioned in the reinforcement structure prior to installation of the through-pin system;

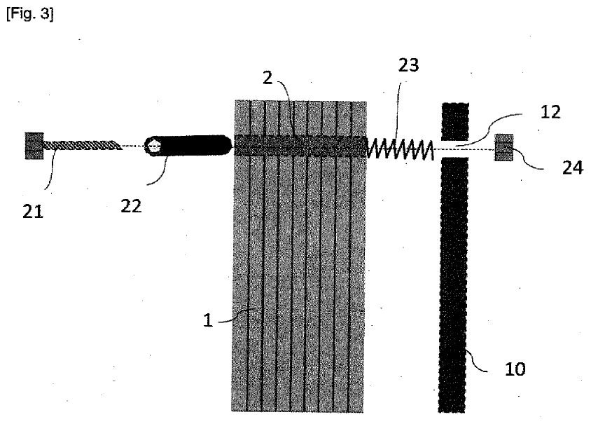

FIG. 3 is a schematic side view of the through pin system before installation; and

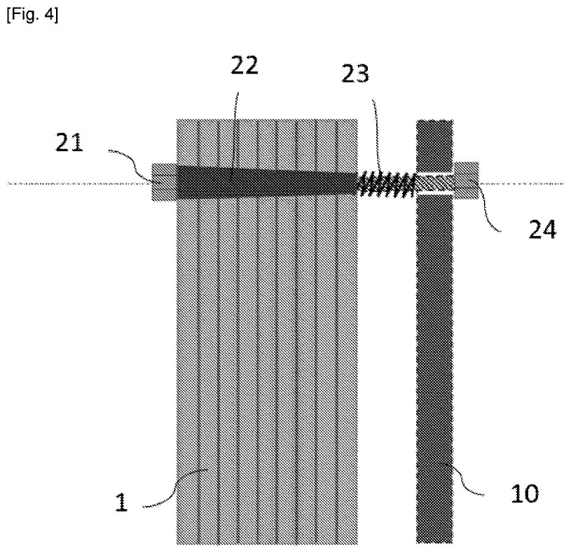

FIG. 4 is a schematic side view of the through-pin system with a tapered profile sleeve, after fastening an assembly according to the invention.

With reference to FIG. 1, the body wall of an armored land vehicle forms an outer frame structure 10, seen here from outside the vehicle.

The transparent ballistic unit 1 has all the characteristics of the invention described previously, and is designed to be fastened to the front face of the armature 10, opposite an opening 11 in the armature 10. The surface area of the ballistic unit 1 is larger than that of the opening 1, so that the ballistic unit 1 can completely cover this opening 11, with an overhang. On the one hand, it is through this overhang of the ballistic unit 1 that it is fixed to the armature 10, as detailed below, on the other hand, in the fixed position of the ballistic unit 1, it is in abutment against the front or outer face of the armature 10.

An external armature structure consists of brackets rigidly connected to the armature 10 and protruding from the front face of the armature 10, comprising at least two brackets 13 designed to support the ballistic unit 1 by its lower lateral face, and almost all its weight, securing the ballistic unit 1 in its vertical position, and at least two brackets 14 in right and left position with respect to the ballistic unit 1, so as to secure it in its horizontal position. When the ballistic unit 1 is in the fastened position, contact between the block 1 and each bracket 13, 14 is made by an elastomer pad 15.

The ballistic unit 1 comprises bores 2 designed to receive through-pins which are not shown and which, in the fastened position of the ballistic unit 1, each face a corresponding bore 12 in the armature 10.

Referring to FIG. 2, the ballistic unit is positioned in its fixing position, held and locked by the front face of armature 10, and brackets 13, 14.

With reference to FIG. 2 and FIG. 3, each pair of bores 2, 12 cooperates with a through-pin consisting of a screw 21, an elastomer sleeve 22, a spring 23 and a nut 24, to help secure the ballistic unit 1 to the armature 10. The elastomer sleeve 22 has external dimensions identical to the dimensions of bore 2, including a sleeve length 22 identical to the thickness of ballistic unit 1. In the fastening position of the ballistic unit 1, the elastomer sleeve 22 is introduced into the bore 2, and the screw 21 from the outside into the hollow cylindrical volume inside the elastomer sleeve 22, so as to pass through the thickness of the ballistic unit 1 and that of the armature 10 and be screwed to a nut 24 in contact with the rear or inner face of the armature 10. A spring 23 is positioned between the rear or inner face of the ballistic unit 1 and the front or outer face of the armature 10, so as to be stressed to a length of between 50% and 100% of its unloaded length.

With reference to FIG. 4, the elastomer sleeve 22 has a conical outer envelope, the small cross-section of which is oriented towards the armature 10. The cylindrical hollow of the elastomer sleeve 22 is coaxial with the conical envelope. This tapered profile provides a better balance between the force exerted by the screw 21+sleeve 22 assembly, which holds the glass sheet (ballistic unit 1) in position on the armature 10, and the force exerted by the spring 23, which tends to push the glass sheet 1 away from the armature 10.

The screw 21 has a hexagonal head. This is preferable for better control of the tightening torque, and indirectly of the degree of spring 23 compression at the end of installation.

1. A ballistic unit essentially consisting of a laminated glass panel of 4 to 10 sheets of mineral glass with thicknesses of between 4 and 12 mm, bonded in consecutive pairs by an adhesive interlayer with a thickness of between 0.1 and 6 mm, wherein a length of two main faces of each said sheets of mineral glass is between 400 and 2000 mm and a width of the two main faces is between 150 and 500 mm, a thickness of the ballistic unit is between 40 and 100 mm, wherein the ballistic unit comprises through-bores in a direction of the thickness thereof, wherein a diameter of the through-bores is between 1/10 and ⅓ of the thickness of the ballistic unit and between 4 and 33 mm, and wherein the through-bores are positioned along three of the four sides or edges of the two main faces of each said sheet of mineral glass, so that centers of the through-bores are at a distance from said corresponding side or edge of at least twice their diameters, and wherein the through-bores are aligned, regularly spaced from one another and in a number such that a sum of the diameters of the through-bores aligned along said side or edge does not exceed ¼ of the length of said side or edge.

2. The ballistic unit according to claim 1, wherein each said sheet of mineral glass is made of soda-lime glass, aluminosilicate, borosilicate is chemically strengthened, thermally toughened, hardened or unhardened.

3. The ballistic unit according to claim 1, wherein each said adhesive interlayer is selected from a layer of polyvinyl butyral (PVB), polyurethane (PU), ethylene-vinyl acetate copolymer (EVA), polycarbonate (PC), polyethylene terephthalate (PET), casting resin or ionomer resin, or a combination of several of these layers.

4. The ballistic unit according to claim 1, wherein a main face of the ballistic unit on a side opposite that from which an impact is expected is made of a polycarbonate shatterproof sheet.

5. The ballistic unit according to claim 1, wherein the thickness of the ballistic unit is at least equal to 60 mm.

6. A kit comprising a ballistic unit according to claim 1, through-pins each intended to participate in a fastening of the ballistic unit through its mounting environment and through each said through-bore, the through-pins each consisting of a screw, an elastomer sleeve, a spring and a nut, for fastening the ballistic unit securely to its mounting environment.

7. The kit according to claim 6, wherein each elastomer sleeve has a length equal to the thickness of the ballistic unit.

8. The kit according to claim 6, wherein each elastomer sleeve has an outer envelope with a geometry identical to that of the through-bore of the ballistic unit, into which the elastomer sleeve is intended to be inserted.

9. The kit according to claim 6, wherein each elastomer sleeve has a cylindrical recess with an internal diameter equal to the diameter of its associated screw.

10. The kit according to claim 6, wherein at least one elastomer sleeve has a conical outer envelope whose small cross-section is oriented towards armature.

11. The kit according to claim 6, wherein the screw has a hexagonal head.

12. An assembly with increased resistance to bullets and/or shrapnel and/or other high-energy projectiles, comprising a ballistic unit, elements for fastening the ballistic unit to a mounting environment, and said mounting environment, wherein one face of said ballistic unit intended to be in contact with an external atmosphere is defined as a front face, an opposite face intended to be in contact with an interior volume of the mounting environment is defined as a rear face, and any faces perpendicular to the front and rear faces are side faces of the ballistic unit, the rear face of the ballistic unit is of dimensions greater than those of an opening in a wall of the mounting environment, in front of which said ballistic unit is intended to be fastened, said wall constitutes an armature having a front or outer face and a rear or inner face, the front face of armature constitutes an element for holding and locking said rear face of the ballistic unit, wherein said assembly comprises an outer armature structure which consists of brackets rigidly connected to armature and protruding past the front face thereof, which comprise at least two brackets supporting the ballistic unit by its lower lateral face, and almost all its weight, securing the ballistic unit in its vertical position, and at least two brackets in right and left position with respect to the ballistic unit, so as to secure it the ballistic unit in its horizontal position, wherein said elements for fastening the ballistic unit comprise through-pins which are each made up of a screw, an elastomer sleeve, a spring and a nut, for fastening the ballistic unit securely to armature, wherein each screw is inserted into an elastomer sleeve, wherein all the screws and elastomer sleeves pass through the ballistic unit via bores drilled therein, wherein each nut is in contact with the inner face of armature, opposite a bore therein, wherein each spring is placed between the outer face of armature and the rear face of the ballistic unit, and wherein in the fastened position of the ballistic unit, each screw is secured to a nut, and each spring is constrained to a length of between 50 and 100% of its no-load length.

13. The assembly according to claim 12, wherein each bracket is in contact with a side face of the ballistic unit via an elastomer pad.

14. A method comprising providing a ballistic unit according to claim 1, as a glass panel with increased resistance to bullets and/or shrapnel and/or other high-energy projectiles.

15. The method according to claim 14 as a side glass panel for armored vehicles.

16. The ballistic unit according to claim 2, wherein each said sheet of mineral glass is made of float glass.

17. The ballistic unit according to claim 4, wherein a main face of the ballistic unit is in contact with an interior of a vehicle or building in the mounting position.
